(19) United States
(12) Patent Application Publication
(10) Pub. No.: US 2017/0058869 A1
(43) Pub. Date: Mar. 2, 2017

(54) CONDUIT ASSEMBLY FOR A LIGHTNING PROTECTION CABLE OF A WIND TURBINE ROTOR BLADE

(71) Applicant: General Electric Company, Schenectady, NY (US)

(72) Inventors: Christopher Daniel Caruso, Greenville, SC (US); Aaron A. Yarbrough, Greenville, SC (US); Daniel Alan Hynum, Simpsonville, SC (US); James Robert Tobin, Simpsonville, SC (US)

(21) Appl. No.: 14/837,187

(22) Filed: Aug. 27, 2015

(51) Int. Cl. F03D 11/00; F03D 1/06

(52) U.S. Cl. CPC F03D 11/0033; F03D 1/0675

(57) ABSTRACT

The present disclosure is directed to a conduit assembly for securing a lightning protection cable of a wind turbine lightning protection system within an internal cavity of a wind turbine rotor blade. The conduit assembly includes one or more conduit members arranged together to define an open passageway configured to receive at least a portion of the lightning protection cable along a length thereof. Further, the conduit member(s) include one or more weldable surfaces. Thus, the weldable surface(s) are configured for securement within the internal cavity of the rotor blade to at least one of a blade segment, opposing spar caps, a shear web of the rotor blade, or any other suitable blade component. More specifically, the weldable surface(s) are constructed, at least in part, of a thermoplastic material such that the conduit members can be easily welded to one or more of the blade components as described herein.

### FIELD OF THE INVENTION

The present invention relates generally to the field of wind turbines, and more particularly to a conduit assembly for securing a lightning protection cable within a rotor blade of a wind turbine using thermoplastic welding.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

The rotor blades typically consist of a suction side shell and a pressure side shell that define an internal cavity when arranged together. Typically, an internal shear web extends between the pressure and suction side shell members and is bonded to opposing spar caps affixed to the inner surfaces of the shell members. In addition, wind turbines typically include a lightning protection system having one or more lightning receptors disposed on the exterior of the pressure and/or suction side shells of the rotor blade and a lightning protection cable electrically coupling the lightning receptor(s) to ground. Thus, the lightning protection cable typically extends through the internal cavity of the rotor blade from the blade tip to the blade root and down through the tower to a ground location. Accordingly, when lightning strikes the rotor blade, the electrical current may flow through the lightning receptor(s) and may be conducted through the lightning protection cable to the ground.

The lightning protection cable is typically attached directly within the rotor blade (e.g. to the shear web and/or to an internal surface of the body shell) using fiberglass laminates and bond paste. Thus, stresses and strains experienced by the rotor blade pass directly to the lightning protection cable. Such stresses and strains can cause damage and/or breakage to the lightning protection cable, thereby requiring immediate repair to ensure the lightning protection system remains operable. In addition, the process of attaching the lightning protection cable to the blade shell can be tedious and time-consuming.

Accordingly, there is a need for improved and effective systems and methods for securing the lightning protection cable of the lighting protection system to the rotor blade of the wind turbine.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a conduit assembly for securing a lightning protection cable of a wind turbine lightning protection system within an internal cavity of a wind turbine rotor blade. The conduit assembly includes one or more conduit members arranged together to define an open passageway configured to receive at least a portion of the lightning protection cable along a length thereof. Further, the conduit member(s) include one or more weldable surfaces. Thus, the weldable surface(s) are configured for securement to at least one of a blade segment, opposing spar caps, a shear web of the rotor blade, or any other suitable blade component. More specifically, the one or more weldable surfaces are constructed, at least in part, of a thermoplastic material such that the conduit members can be easily welded to one or more of the blade components, e.g. also constructed at least in part of a thermoplastic material, as described herein.

For example, in one embodiment, the blade segment, the opposing spar caps, and/or the shear web of the rotor blade may be constructed, at least in part, of a thermoplastic material. In another embodiment, the weldable surface(s) may include one or more flanges. Thus, in certain embodiments, the weldable surface(s) of the conduit member(s) may be welded to the shear web. Alternatively, the weldable surfaces of the conduit member(s) may be welded to one or more blade segments. In still another embodiment, the weldable surface(s) of the conduit member(s) may be welded to the shear web and the one or more blade segments. In yet another embodiment, the weldable surfaces of the conduit member(s) may be welded to one or more of the opposing spar caps.

In additional embodiments, one or more of the conduit members may be reinforced with one or more fiber materials, including but not limited to glass fibers, carbon fibers, metal fibers, polymer fibers, ceramic fibers, nanofibers, or similar, or any combinations thereof.

In further embodiments, the conduit member(s) may be formed via at least one of pultrusion, vacuum infusion, resin transfer molding (RTM), light resin transfer molding (RTM), vacuum assisted resin transfer molding (VARTM), a belt-pressing process, a forming process, injection molding, extrusion, vacuum forming, thermoforming, blow molding, or any other suitable manufacturing process.

In yet another embodiment, the conduit member(s) may include any suitable cross-sectional shape so as to accommodate the lightning protection cable therein. For example, in certain embodiments, the cross-sectional shape may include at least one of the following cross-sectional profiles: omega-shaped, square, elliptical, U-shaped, C-shaped, L-shaped, triangular, rectangular, round, arcuate, or similar.

In another aspect, the present disclosure is directed to a rotor blade assembly for a wind turbine. The rotor blade assembly includes a blade root, a blade tip, and at least one blade segment arranged between the blade root and the blade tip. Further, the blade segment includes a pressure side and a suction side arranged together to define an internal cavity. The rotor blade assembly also includes opposing spar caps configured on opposing internal surfaces of the pressure and suction sides and at least one shear web configured between the opposing spar caps. In addition, at least one of the blade segment, one or more of the spar caps, and/or the shear web may be constructed, at least in part, of a thermoplastic material. The rotor blade assembly further includes a lightning protection cable configured at least partially within the internal cavity. The lightning protection cable is configured to electrically couple a plurality of lightning receptors so as to form a conductive circuit. Further, the rotor blade assembly includes a conduit assembly configured to receive at least a portion of the lightning protection cable along a length thereof. The conduit assembly is constructed, at least in part, of a thermoplastic material. As such, the conduit assembly may be welded to the blade segment, one or more of the spar caps, the shear web, and/or any other suitable blade component within the internal cavity. It should be understood that the conduit assembly may be further configured according to any of the embodiments as described herein.

In yet another aspect, the present disclosure is directed to a method for securing a lightning protection cable within an internal cavity of a rotor blade of wind turbine. The method includes placing the lightning protection cable at least partially within a passageway of a conduit assembly. The conduit assembly may be constructed, at least in part, of a thermoplastic material. Thus, the method also includes welding the conduit assembly within the internal cavity of the rotor blade to at least one of an inner surface of a blade segment, one or more spar caps, and/or a shear web of the rotor blade so as to secure the lightning protection cable therein. Further, the blade segment(s), the one or more spar caps, and/or the shear web may be constructed, at least in part, of a thermoplastic material. Accordingly, the thermoplastic conduit assembly can be easily welded to one or more of the various internal blade components of the rotor blade. In addition, it should be understood that the method steps as described herein may be performed in any suitable order and are not limited to the order described herein. For example, in one embodiment, the method may include welding the conduit assembly within the internal cavity of the rotor blade and then placing the lightning protection cable at least partially within a passageway of the conduit assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates a cross-sectional view of the rotor blade of FIG. 2 along line 3-3;

FIG. 4 illustrates a perspective view of one embodiment of a wind turbine, particularly illustrating a lighting protection system configured thereon according to the present disclosure;

FIG. 5 illustrates a perspective view of one embodiment of a rotor blade, particularly illustrating a plurality of lighting receptors connected by a lightning protection cable according to the present disclosure;

FIG. 6 illustrates a cross-sectional view of one embodiment of a rotor blade according to the present disclosure, particularly illustrating a thermoplastic conduit assembly welded to a shear web of the rotor blade;

FIG. 7 illustrates a cross-sectional view of one embodiment of a rotor blade according to the present disclosure, particularly illustrating a thermoplastic conduit assembly welded to an inner surface of a blade segment of the rotor blade;

FIG. 8 illustrates a side view of one embodiment of a blade root of a rotor blade, particularly illustrating a conduit assembly welded within an internal cavity of the rotor blade according to the present disclosure;

FIG. 9 illustrates a cross-sectional view of one embodiment of a conduit member welded to a rotor blade so as to secure a lightning protection cable within an internal cavity of the rotor blade according to the present disclosure;

FIG. 10 illustrates a cross-sectional view of another embodiment of a conduit member welded to a rotor blade so as to secure a lightning protection cable within an internal cavity of the rotor blade according to the present disclosure;

FIG. 11 illustrates a cross-sectional view of still another embodiment of a conduit member welded to a rotor blade so as to secure a lightning protection cable within an internal cavity of the rotor blade according to the present disclosure;

FIG. 12 illustrates a cross-sectional view of yet another embodiment of a conduit member welded to a rotor blade so as to secure a lightning protection cable within an internal cavity of the rotor blade according to the present disclosure; and

FIG. 13 illustrates a flow diagram of one embodiment of a method for securing a lightning protection system within a rotor blade of a wind turbine according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention include such modifications and variations as come within the scope of the appended claims and their equivalents.

Generally, the present disclosure is directed to improved assemblies and method for securing a lightning protection cable within a rotor blade of a wind turbine. More specifically, the rotor blade may include one or more blade segments arranged together to form the outer blade shell of the rotor blade and one or more structural components, e.g. opposing spar caps having at least one shear web arranged therebetween, configured within an internal cavity of the rotor blade. In addition, in certain embodiments, the blade segments, the spar caps, and/or the shear web may be constructed, at least in part, of a thermoplastic material. Further, the wind turbine may include a lightning protection system having a lightning protection cable that electrically couples a plurality of lightning receptors configured with the rotor blade so as to form a conductive circuit. Thus, the rotor blade also includes a thermoplastic conduit assembly that is configured to receive at least a portion of the lightning protection cable along a length thereof. Accordingly, due to the similar materials, the conduit assembly can be easily secured within the internal cavity of the rotor blade (e.g. to the shear web and/or the inner surface of the blade segments) via welding so as to maintain a location of the lightning protection cable.

Accordingly, the present disclosure provides many advantages not present in the prior art. For example, the thermoplastic conduit assembly can be quickly and easily installed within the internal cavity of the rotor blade via welding, thereby improving cycle time, costs, and complexity. Further, the present disclosure is configured to reduce deflection and/or strain transfer between the rotor blade and the lightning protection cable since the lightning protection cable is not directly secured to the rotor blade. Thus, the stresses and strains experienced by the rotor blade will not pass to the lightning protection cable. Accordingly, the life of the cable is increased under fatigue loading. In addition, the conduit assembly allows the lightning protection cable to be placed with better precision than prior art methods that included infusing the cable to the shear web.

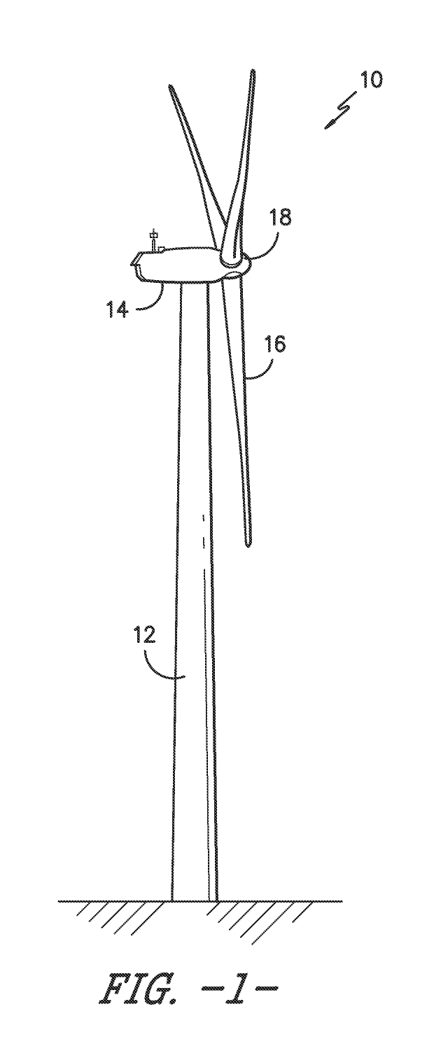

Referring to the drawings, FIG. 1 illustrates a perspective view of a horizontal axis wind turbine 10. It should be appreciated that the wind turbine 10 may also be a vertical-axis wind turbine. As shown in the illustrated embodiment, the wind turbine 10 includes a tower 12, a nacelle 14 mounted on the tower 12, and a rotor hub 18 that is coupled to the nacelle 14. The tower 12 may be fabricated from tubular steel or other suitable material. The rotor hub 18 includes one or more rotor blades 16 coupled to and extending radially outward from the hub 18. As shown, the rotor hub 18 includes three rotor blades 16. However, in an alternative embodiment, the rotor hub 18 may include more or less than three rotor blades 16. The rotor blades 16 rotate the rotor hub 18 to enable kinetic energy to be transferred from the wind into usable mechanical energy, and subsequently, electrical energy. Specifically, the hub 18 may be rotatably coupled to an electric generator (not illustrated) positioned within the nacelle 14 for production of electrical energy.

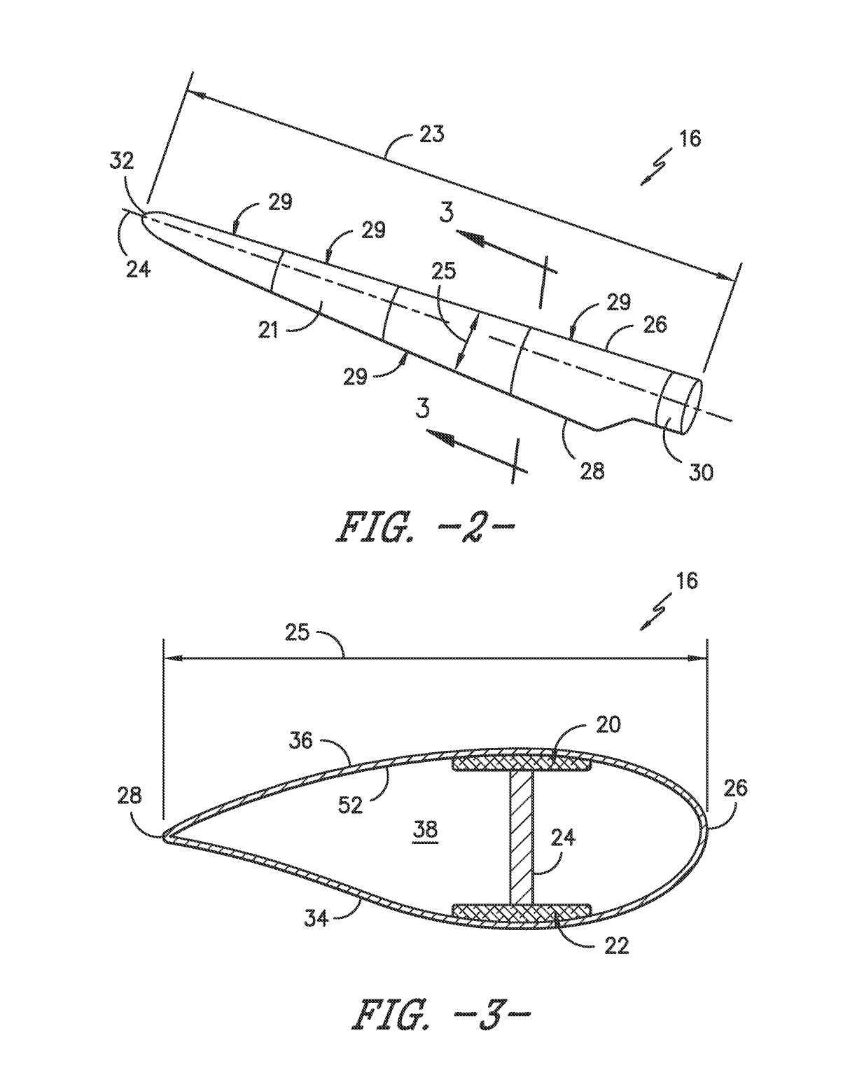

Referring now to FIGS. 2 and 3, one embodiment of a rotor blade 16 for use with a wind turbine 10 is illustrated in accordance with aspects of the present subject matter. In particular, FIG. 2 illustrates a perspective view of one embodiment of the rotor blade 16. FIG. 3 illustrates a cross-sectional view of the rotor blade 16 along the sectional line 3-3 shown in FIG. 2. As shown, the rotor blade 16 generally includes a blade root 30 configured to be mounted or otherwise secured to the hub 18 (FIG. 1) of a wind turbine 10 and a blade tip 32 disposed opposite the blade root 30. A body shell 21 of the rotor blade generally extends between the blade root 30 and the blade tip 32 along a longitudinal axis 27. The body shell 21 may generally serve as the outer casing/covering of the rotor blade 16 and may define a substantially aerodynamic profile, such as by defining a symmetrical or cambered airfoil-shaped cross-section. The body shell 21 may also define a pressure side 34 and a suction side 36 extending between leading and trailing edges 26, 28 of the rotor blade 16. Further, the rotor blade 16 may also have a span 23 defining the total length between the blade root 30 and the blade tip 32 and a chord 25 defining the total length between the leading edge 26 and the trailing edge 28. As is generally understood, the chord 25 may generally vary in length with respect to the span 23 as the rotor blade 16 extends from the blade root 30 to the blade tip 32.

In several embodiments, the body shell 21 of the rotor blade 16 may be formed as a single, unitary component. Alternatively, the body shell 21 may be formed from a plurality of shell components. For example, the body shell 21 may be manufactured from a first shell half generally defining the pressure side 34 of the rotor blade 16 and a second shell half generally defining the suction side 36 of the rotor blade 16, with such shell halves being secured to one another at the leading and trailing edges 26, 28 of the blade 16. In addition, as shown in FIG. 2, the body shell 21 may be formed from multiple blade segments 29. More specifically, the rotor blade 16 may be configured according to U.S. application Ser. No. 14/753,137 filed Jun. 29, 2015 entitled “Modular Wind Turbine Rotor Blades and Methods of Assembling Same” which is incorporated herein by reference in its entirety.

It should be understood that the body shell 21 may generally be formed using any suitable material, including but not limited to a thermoset material, a thermoplastic material, one or more fiber materials, and/or combinations thereof. For instance, in one embodiment, the body shell 21 may be formed entirely from a laminate composite material, such as a carbon fiber reinforced laminate composite or a glass fiber reinforced laminate composite. Alternatively, one or more portions of the body shell 21 may be configured as a layered construction and may include a core material, formed from a lightweight material such as wood (e.g., balsa), foam (e.g., extruded polystyrene foam) or a combination of such materials, disposed between layers of laminate composite material. In alternative embodiments, the body shell 21 may be formed, at least in part, from a fiber-reinforced thermoplastic material.

Referring particularly to FIG. 3, the rotor blade 16 may also include one or more longitudinally extending structural components configured to provide increased stiffness, buckling resistance and/or strength to the rotor blade 16. For example, the rotor blade 16 may include a pair of longitudinally extending spar caps 20, 22 configured to be engaged against the opposing inner surfaces of the pressure and suction sides 34, 36 of the rotor blade 16, respectively. Additionally, one or more shear webs 24 may be disposed between the spar caps 20, 22 so as to form a beam-like configuration. The spar caps 20, 22 may generally be designed to control the bending stresses and/or other loads acting on the rotor blade 16 in a generally span-wise direction (a direction parallel to the span 23 of the rotor blade 16) during operation of a wind turbine 10. Similarly, the spar caps 20, 22 may also be designed to withstand the span-wise compression occurring during operation of the wind turbine 10.

It should also be understood that the spar caps 20, 22 and/or the shear web(s) 24 may generally be formed from any suitable material, including but not limited to a thermoset material, a thermoplastic material, and/or combinations thereof. For instance, in one embodiment, the spar caps 20, 22 and/or the shear web(s) 24 may be formed entirely from a laminate composite material, such as a carbon fiber reinforced laminate composite or a glass fiber reinforced laminate composite. Alternatively, the spar caps 20, 22 and/or the shear web(s) 24 may be formed, at least in part, from a thermoplastic material.

The thermoplastic materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material. Further, the thermoset materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material.

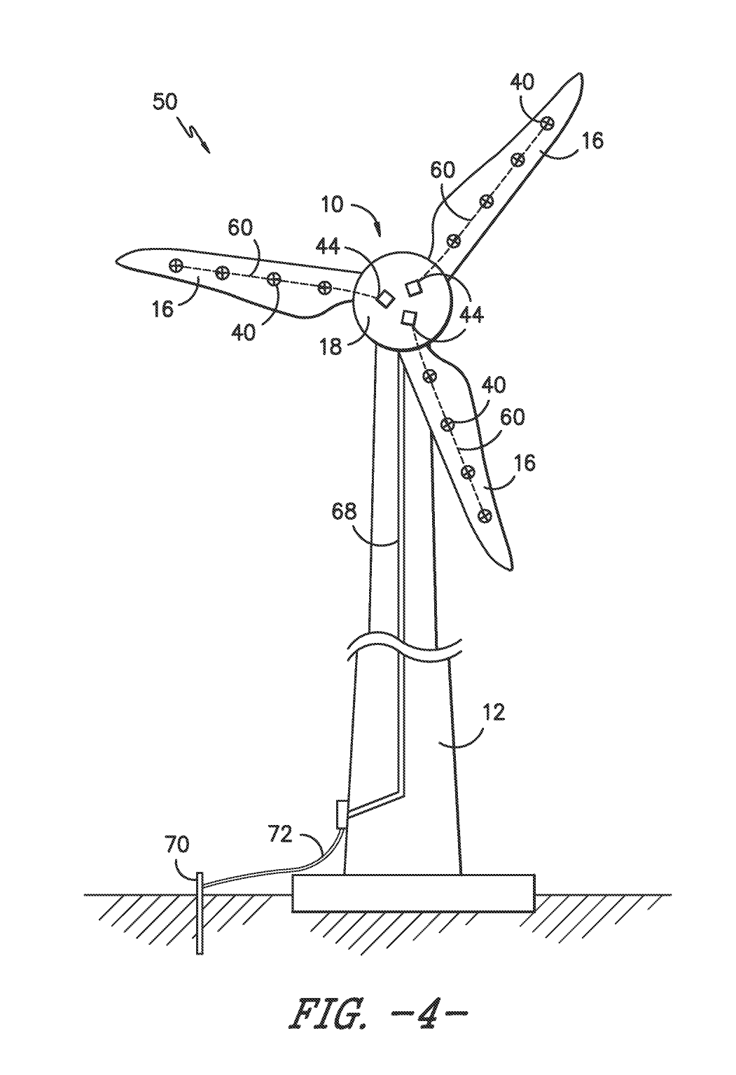

Referring now to FIG. 4, a perspective view of one embodiment of a wind turbine 10 having a lightning protection system 50 configured thereon is illustrated. As shown, the lightning protection system 50 includes a plurality of lightning receptors 40 configured along either or both pressure or suction sides 34, 36 of the rotor blade 16. Further, as shown, each rotor blade 16 includes a conductive circuit 60 having a plurality of lightning receptors 40 connected via one or more lightning protection cables 41 configured within the internal cavity 38 of the rotor blade 16. The respective lightning conductive circuits 60 for each of the rotor blades 16 include terminal ends 44 that extend through the root portion of the rotor blades 16 and are individually connected to a grounding system within the rotor hub 18. The grounding system may be variously configured, as is well known in the art. For example, the grounding system may include any conductive path defined by the wind turbine's machinery or support structure, including blade bearings, machinery bed plates, tower structure, and the like, that defines any suitable ground conductive path 68 from the blades 16, through the tower 12, to a ground rod 70 via a ground cable 72, or other suitable electrical ground path.

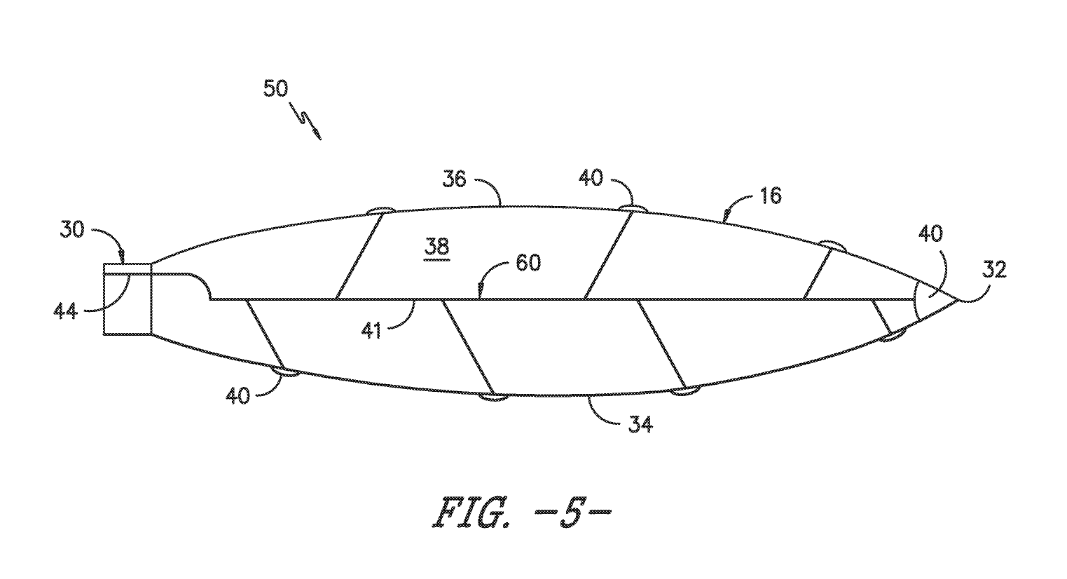

Referring now to FIG. 5, a cross-sectional view of one embodiment of a rotor blade 16 having a lightning protection system 50 configured within an internal cavity 38 thereof is illustrated. As shown, the lightning protection system 50 includes conductive circuit 60 illustrated within the internal cavity 38 of the rotor blade 16. In other embodiments, the conductive circuit 60 may be defined by components that are embedded in the blade 16, or are external to the blade 16, for example along the outer surfaces of the blade 16. More specifically, as shown, the conductive circuit 60 includes a plurality of lightning receptors 40 connected via one or more lightning protection cables 41. In various embodiments, the lightning receptors 40 may be configured along either or both of the pressure or suction sides 36, 34. For example, in the illustrated embodiment, the lightning receptors 40 are provided on each of the pressure and suction sides 36, 34. In an alternative embodiment, the lightning receptors 40 may be provided on only one of the sides 36, 34. It should be understood that the lightning receptors 40 may be variously configured within the scope and spirit of the invention, and may include any metal or metalized component (i.e., a metal screen, a metal rod or tip, and the like) mounted on the pressure or suction sides 36, 34 of the rotor blade 16 for the purpose of conducting lightning strikes to a ground. Further, the lightning protection cable(s) 41 may have a gauge suitable for defining a conductive leg for transmitting a lightning strike on any one of the receptors 40 to a ground via connection of the conductive terminal end 44 to the wind turbine's ground system.

Still referring to FIG. 5, each rotor blade 16 may include a single conductive circuit 60, as depicted, with each of the lightning receptors 40 configured in series within the single circuit 60. In an alternative embodiment, the rotor blade 16 may include a plurality of circuits 60, with each of the lightning receptors 40 configured in one of the respective circuits 60. In still further embodiments, the receptors 40 may be connected in any suitable fashion via the lightning protection cable 41 and it should be understood that the embodiment of FIG. 5 is provided for example purposes only and is not intended to be limiting.

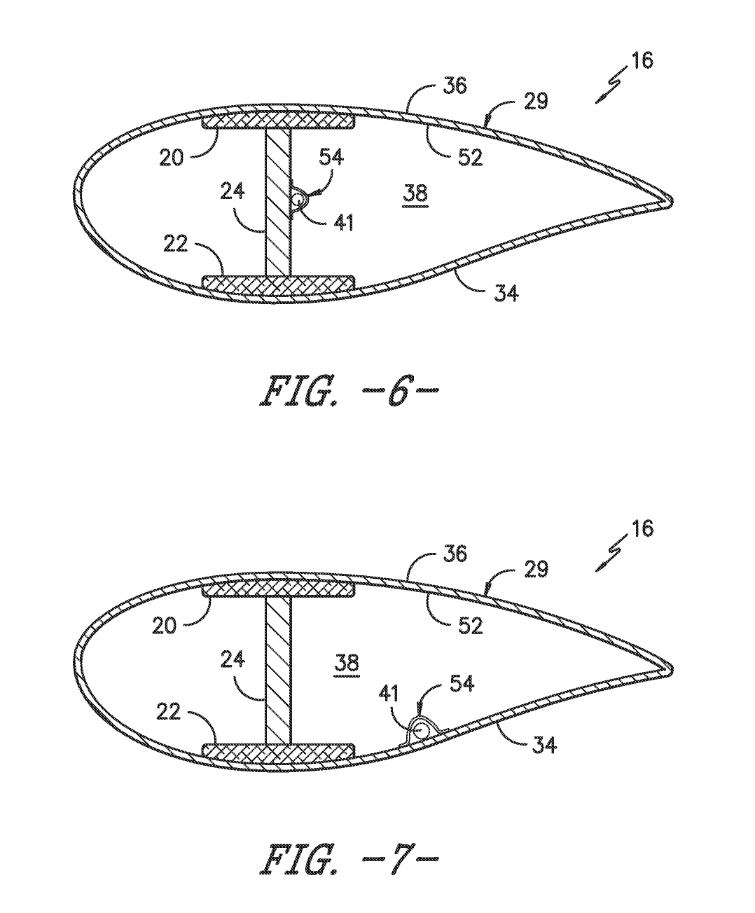

Referring now to FIGS. 6-7, cross-sectional views of various embodiments of a conduit assembly 54 for securing the lightning protection cable 41 as described herein within the internal cavity 38 are illustrated. More specifically, as shown, in FIG. 6, the lightning protection cable 41 may be secured to the shear web 24 via the conduit assembly 54. Further, as shown in FIGS. 6 and 8, the lightning protection cable 41 may be secured to the shear web 24 such that the cable 41 runs along a middle portion of the shear web 24 from the blade tip 30 until the shear web 24 ends near the blade root 30. In such embodiments, as shown in FIG. 8, once the shear web 24 ends, the lightning protection cable 41 may run along an edge of the shear web 24 to an inner surface 52 of the internal cavity 38 of the rotor blade 16. Thus, in various embodiments, the conduit assembly 54 is configured to receive at least a portion of the lightning protection cable 41 along a length thereof between the shear web 24 and the blade root 30. In addition, as shown in FIG. 7, the lightning protection cable 41 may be secured to the inner surface 52 of the pressure and/or suction sides 34, 36 of the body shell 21 along at least a portion of the span 23 of the rotor blade 16, i.e. rather than being secured to the shear web 24. Accordingly, the conduit assembly 54 is configured to maintain a location of the lightning protection cable 41 without requiring the lightning protection cable 41 to be secured directly to the rotor blade 16. As such, the lightning protection cable 41 is free to move within the conduit assembly 54 when installed.

In addition, the conduit assembly 54 is constructed, at least in part, of a thermoplastic material. Thus, at least a portion of the thermoplastic conduit assembly 54 can be easily welded to the shear web 24, the spar caps 20, 22, the blade segments 29, and/or any other suitable rotor blade component, which will be described in more detail below.

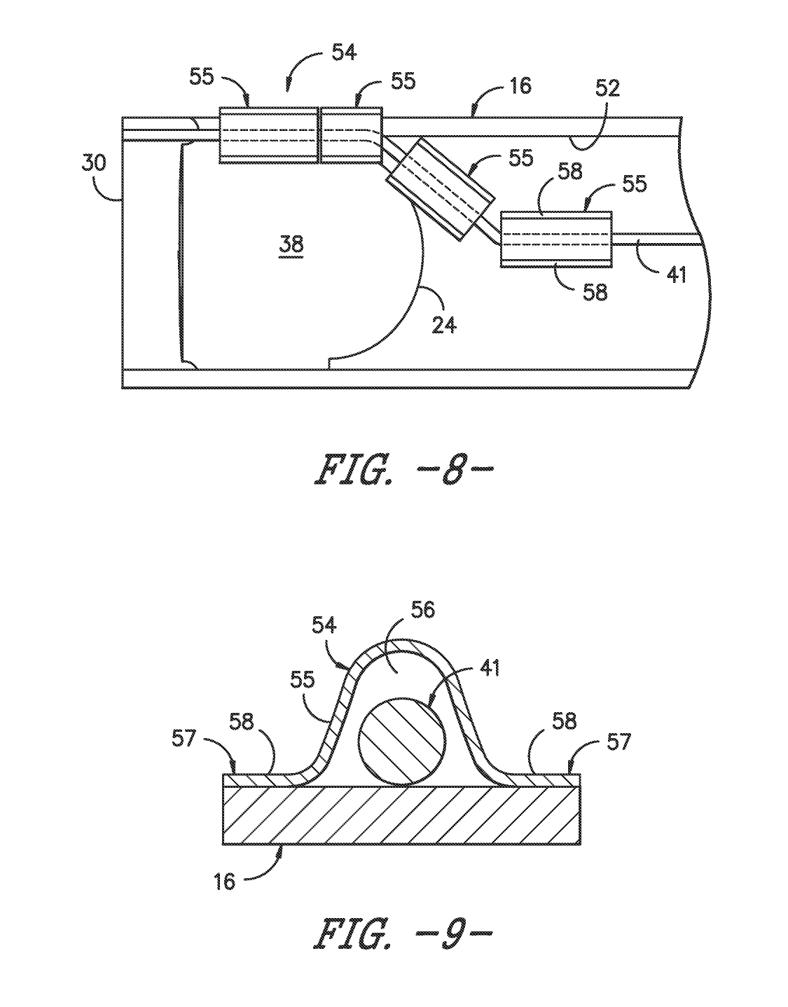

More specifically, as shown in FIGS. 9-12, the conduit assembly 54 defines an open passageway 56 configured to receive the lightning protection cable 41 therein. Thus, the conduit assembly 54 is configured to maintain the location of the cable 41 within the internal cavity 38 of the rotor blade 16, while also allowing the cable 41 to freely move within the passageway since the cable 41 is not directly attached the rotor blade 16. More specifically, as shown in FIG. 8, the conduit assembly 54 may include one or more conduit members 55 configured to secure at least a portion of the lightning protection cable 41 along a length thereof within the internal cavity 38 of the rotor blade 16. For example, as shown in the illustrated embodiment, the conduit assembly 54 includes four conduit members 55. In further embodiments, the conduit assembly 54 may include more than four or less than four conduit members 55. Thus, the separate conduit members 55 can be easily arranged along the length of the lightning protection cable 41, which may be straight in certain areas and angled in others.

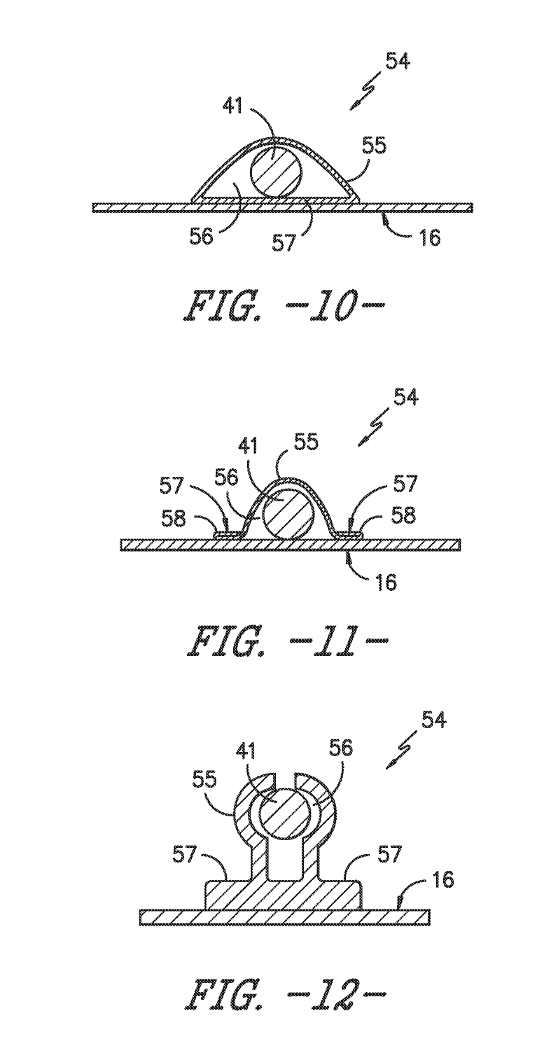

As shown generally in the figures, the conduit members 55 may include any suitable cross-sectional profile so as to receive the lightning protection cable 41 therein, including, but not limited to any of the following cross-sectional profiles: omega-shaped, square, elliptical, U-shaped, C-shaped, L-shaped, triangular, rectangular, round, or similar or any combinations thereof. For example, as shown in FIGS. 9 and 11, the conduit members 55 have a substantially omega-shaped cross-sectional shape. Alternatively, as shown in FIG. 10, the conduit member 55 may have a closed cross-section with a substantially arcuate or semi-hemispherical shape.

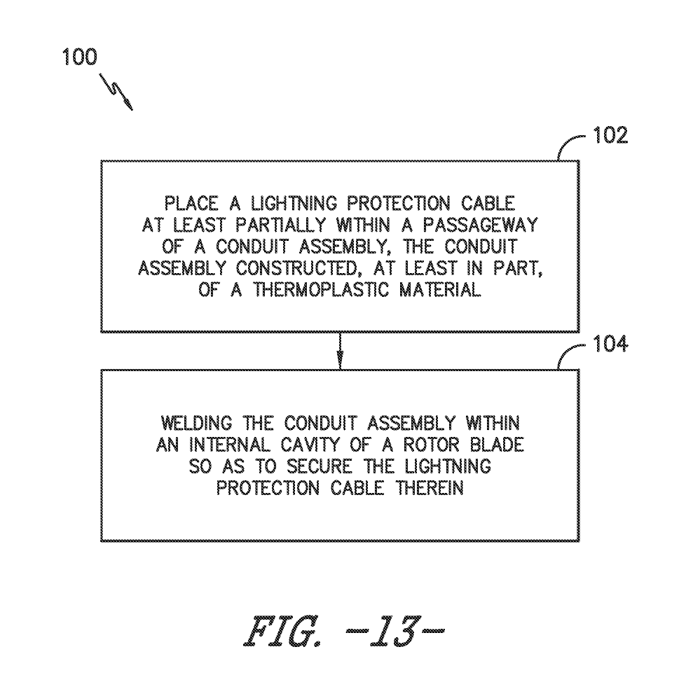

In addition, as shown in FIG. 12, the conduit member(s) 55 may have a multi-segmented configuration such that lightning protection cable 41 fits between the multiple segments to allow for easier insertion within the conduit assembly 54. For example, as shown in FIG. 12, the cross-section of the conduit member 55 may include two opposing generally C-shaped members that form an open passageway for the lightning protection cable 41 to fit therein.

It should be understood that the conduit member(s) 55 may be formed using any suitable means. For example, in certain embodiments, the conduit member(s) 55 of the conduit assembly may be formed via at least one of pultrusion, vacuum infusion, resin transfer molding (RTM), light resin transfer molding (RTM), vacuum assisted resin transfer molding (VARTM), a belt-pressing process, a forming process, injection molding, extrusion, vacuum forming, thermoforming, blow molding, or any other suitable manufacturing process. As used herein, the terms “pultrusion” generally encompasses processes that utilize reinforced materials (e.g. fibers or woven or braided strands) that are impregnated with a resin and pulled through a stationary die such that the resin cures or undergoes polymerization. As such, the pultrusion process is typically characterized by a continuous process of composite materials that produces composite parts having a constant cross-section. Thus, the conduit member(s) 55 may include pultrusions constructed of reinforced thermoplastic materials. Further, the conduit member(s) 55 may be formed of the same pre-cured composites or different pre-cured composites. In addition, the conduit member(s) 55 may be reinforced with one or more fiber materials, including but not limited to glass fibers, carbon fibers, metal fibers, polymer fibers, ceramic fibers, nanofibers, or similar, or any combinations thereof.

Referring generally to FIGS. 9-12, the conduit assembly 54 may be attached to the rotor blade 16 using any suitable means. For example, as shown, the conduit member(s) 55 of the conduit assembly 54 may include one or more weldable surfaces 57. Thus, the weldable surface(s) 57 are configured for securement to any suitable location within the internal cavity 38 of the rotor blade 16 (e.g. the blade segment(s) 29, the opposing spar caps 20, 22, the shear web 24 and/or any other suitable blade component) constructed, at least in part, of a thermoplastic material. More specifically, the weldable surface(s) 57 may be constructed, at least in part, of a thermoplastic material such that the conduit members 55 can be easily welded to one or more of the blade components as described herein.

For example, as shown in FIGS. 9 and 11, the weldable surface(s) may include one or more flanges 58. In such embodiments, the flange(s) 58 may be secured to the rotor blade 16 via welding. Alternatively, as shown in FIGS. 10 and 12, the weldable surface(s) 57 may correspond to a bottom surface of the one or more conduit members 55. In such embodiments, the bottom surface of the conduit members may be secured to the rotor blade 16 via welding. Suitable welding techniques may include but are not limited to ultrasonic welding, induction welding, friction stir welding, fiber optics infrared welding, chemical welding, ultraviolet heating and resistance welding, or any other suitable welding techniques.

Referring now to FIG. 13, a flow diagram of a method 100 for securing a lightning protection cable 41 within an internal cavity 38 of a rotor blade 16 of wind turbine 10 is illustrated. As shown at 102, the method 100 includes placing the lightning protection cable 41 at least partially within a passageway 56 of a conduit assembly 54. The conduit assembly 54 is constructed, at least in part, of a thermoplastic material. Thus, the method 100 also includes welding the conduit assembly 54 within the internal cavity 38 of the rotor blade 16 so as to secure the lightning protection cable 41 therein. More specifically, the method 100 may include welding the conduit assembly 54 to at least one of a blade segment 29, opposing spar caps 20, 22, and/or a shear web 24 of the rotor blade 16. For example, the blade segment(s) 29, the opposing spar caps 20, 22, and/or the shear web 24 may be constructed, at least in part, of a thermoplastic material. As such, the thermoplastic conduit assembly 54 can be easily welded to any suitable thermoplastic blade component using any suitable welding technique.

In addition, it should be understood that the method steps as described herein may be performed in any suitable order and are not limited to the order described herein. For example, in an alternative embodiment, the method may include welding the conduit assembly 54 within the internal cavity 38 of the rotor blade 16 and then placing the lightning protection cable 41 at least partially within a passageway 56 of the conduit assembly 54.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A conduit assembly for securing a lightning protection cable of a wind turbine lightning protection system within an internal cavity of a wind turbine rotor blade, the conduit assembly comprising:
one or more conduit members arranged together to define an open passageway configured to receive at least a portion of the lightning protection cable along a length thereof,
the one or more conduit members comprising one or more weldable surfaces, the one or more weldable surfaces configured for securement to at least one of a blade segment, opposing spar caps, or a shear web of the rotor blade, the one or more weldable surfaces being constructed, at least in part, of a thermoplastic material.

2. The conduit assembly of claim 1, wherein at least one of the blade segment, the opposing spar caps, or the shear web of the rotor blade are constructed, at least in part, of a thermoplastic material.

3. The conduit assembly of claim 2, wherein the weldable surfaces of the one or more conduit members are welded to the shear web.

4. The conduit assembly of claim 2, wherein the weldable surfaces of the one or more conduit members are welded to the at least one blade segment.

5. The conduit assembly of claim 2, wherein one or more of the weldable surfaces of the conduit members are welded to the shear web and one or more of the weldable surfaces of the conduit members are welded to the at least one blade segment.

6. The conduit assembly of claim 2, wherein the weldable surfaces of the one or more conduit members are welded to one or more of the opposing spar caps.

7. The conduit assembly of claim 1, wherein the one or more weldable surfaces comprise one or more flanges.

8. The conduit assembly of claim 1, wherein one or more of the conduit members are reinforced with one or more fiber materials.

9. The conduit assembly of claim 1, wherein the one or more conduit members are formed via at least one of pultrusion, vacuum infusion, resin transfer molding (RTM), light resin transfer molding (RTM), vacuum assisted resin transfer molding (VARTM), a belt-pressing process, injection molding, extrusion, vacuum forming, thermoforming, blow molding, or a forming process.

10. The conduit assembly of claim 1, wherein the one or more conduit members comprise at least one of the following cross-sectional profiles: omega-shaped, square, elliptical, U-shaped, C-shaped, L-shaped, triangular, rectangular, round, or arcuate.

11. A rotor blade assembly for a wind turbine, comprising:
a blade root, a blade tip, and at least one blade segment arranged between the blade root and the blade tip, the blade segment comprising a pressure side and a suction side arranged together to define an internal cavity;
opposing spar caps configured on opposing internal surfaces of the pressure and suction sides;
at least one shear web configured between the opposing spar caps, wherein at least one of the blade segment, the opposing spar caps, or the shear web are constructed, at least in part, of a thermoplastic material;
a lightning protection cable configured at least partially within the internal cavity, the lightning protection cable configured to electrically couple a plurality of lightning receptors so as to form a conductive circuit; and,
a conduit assembly configured to receive at least a portion of the lightning protection cable along a length thereof, the conduit assembly constructed, at least in part, of a thermoplastic material, wherein the conduit assembly is welded to at least one of the blade segment, the opposing spar caps, or the shear web.

12. The rotor blade assembly of claim 11, wherein the conduit assembly comprises one or more conduit members.

13. The rotor blade assembly of claim 12, wherein the one or more conduit members comprises one or more weldable surfaces configured for securement to at least one of the blade segment, the opposing spar caps, or the shear web of the rotor blade, the one or more weldable surfaces being constructed, at least in part, of a thermoplastic material.

14. The rotor blade assembly of claim 13, wherein the weldable surfaces of the one or more conduit members are welded to the shear web.

15. The rotor blade assembly of claim 12, wherein the weldable surfaces of the one or more conduit members are welded to the at least one blade segment.

16. The rotor blade assembly of claim 13, wherein one or more of the weldable surfaces of the conduit members are welded to the shear web and one or more of the weldable surfaces of the conduit members are welded to the at least one blade segment.

17. The rotor blade assembly of claim 13, wherein the weldable surfaces of the one or more conduit members are welded to one or more of the opposing spar caps.

18. The rotor blade assembly of claim 13, wherein the one or more weldable surfaces comprise one or more flanges.

19. The rotor blade assembly of claim 11, wherein the one or more conduit members are formed via at least one of pultrusion, vacuum infusion, resin transfer molding (RTM), light resin transfer molding (RTM), vacuum assisted resin transfer molding (VARTM), a belt-pressing process, injection molding, extrusion, vacuum forming, thermoforming, blow molding, or a forming process.

20. A method for securing a lightning protection cable within an internal cavity of a rotor blade of wind turbine, the method comprising:
placing the lightning protection cable at least partially within a passageway of a conduit assembly, the conduit assembly constructed, at least in part, of a thermoplastic material; and,
welding the conduit assembly within the internal cavity to at least one of an inner surface of a blade segment, one or more spar caps, or a shear web of the rotor blade so as to secure the lightning protection cable therein, wherein at least one of the blade segment, the opposing spar caps, or the shear web are constructed, at least in part, of a thermoplastic material.
